(19) United States
(12) Patent Application Publication
(10) Pub. No.: US 2006/0231275 A1
(43) Pub. Date: Oct. 19, 2006

(54) Tillage point system

(75) Inventors: Reagan Bull, Champaign, IL (US); Jerome Lynch, Mahomet, IL (US)

Correspondence Address: HAYNES AND BOONE, LLP, 901 MAIN STREET, SUITE 3100, DALLAS, TX, 75202, US

(73) Assignee: Alamo Group, Inc., Seguin, TX (US)

(21) Appl. No.: 11/106,217

(22) Filed: Apr. 14, 2005

(51) Int. Cl. A01B 39/20

(52) U.S. Cl. 172/753

(57) ABSTRACT

A tillage point replacement system includes a base operable to mount to a shank and including a first tapered coupling member. A wear surface member is provided that includes a second tapered coupling member operable to couple the wear surface member directly to the base by engaging the first tapered coupling member. The base may be mounted to a shank which is coupled to an agricultural tillage implement. The tillage point system allows the provision of a variety of different wear surfaces for use with a single base and/or the provision of a variety of different bases for use with a single wear surface.

### BACKGROUND

The present disclosure relates generally to agricultural tillage implements, and more particularly to a tillage point system for an agricultural tillage implement.

Tillage points on agricultural tillage implements are used to provide a wear surface for tilling which may differ depending on the desired tillage results. The tillage points are typically coupled to a shank which is mounted to the agricultural tillage implement. The wear surface wears away during the tilling process, resulting in the need to periodically replace the entire tillage point.

A number of issues arise with the coupling of the tillage point to the shank on the agricultural tillage implement. Tillage points are typically single-piece members coupled to the shank by a bolt or a pin which can be time consuming to change. As these conventional tillage points wear, the danger of them allowing wear on the shank requires the tillage point to be replaced before its full potential for wear has been achieve, which increases cost. Efforts to extend the life of the tillage point typically involve the welding of high alloy pieces to the wear surface of the tillage point, which can result in cracking of the high alloy piece. Furthermore, these conventional tillage points are often very difficult to replace, sometimes requiring that the shank be taken out of service for tillage point replacement.

Accordingly, it would be desirable to provide a tillage point system absent the disadvantages found in the prior methods discussed above.

### SUMMARY

According to one embodiment, a tillage point replacement system is provided that includes a base operable to mount to a shank and including a first tapered coupling member. A wear surface member is provided including a second tapered coupling member which is operable to couple the wear surface member directly to the base by engaging the first tapered coupling member.

A principal advantage of this embodiment is that a tillage point replacement system is provided including a wear surface member which is easy to replace and which may be fabricated from a higher grade material in order to provide a more economical replacement system.

### BRIEF DESCRIPTION OF THE DRAWINGS

FIG. 1a is a top perspective view illustrating an embodiment of a base.

FIG. 1b is a bottom perspective view illustrating an embodiment of the base of FIG. 1a.

FIG. 2a is a top perspective view illustrating an embodiment of a wear surface member used with the base of FIG. 1a.

FIG. 2b is a bottom perspective view illustrating an embodiment of the wear surface member of FIG. 2a.

FIG. 2c is a top perspective view illustrating an embodiment of a wear surface member used with the base of FIG. 1a.

FIG. 2d is a top perspective view illustrating an embodiment of a wear surface member used with the base of FIG. 1a.

FIG. 2e is a top perspective view illustrating an embodiment of a wear surface member used with the base of FIG. 1a.

FIG. 2f is a top perspective view illustrating an embodiment of a wear surface member used with the base of FIG. 1a.

FIG. 2g is a top perspective view illustrating an embodiment of a wear surface member used with the base of FIG. 1a.

FIG. 2h is a top perspective view illustrating an embodiment of a wear surface member used with the base of FIG. 1a.

FIG. 2i is a top perspective view illustrating an embodiment of a wear surface member used with the base of FIG. 1a.

FIG. 3a is a bottom perspective view illustrating an embodiment of the wear surface member of FIG. 2a being coupled to the base of FIG. 1a.

FIG. 3b is a bottom perspective view illustrating an embodiment of the wear surface member of FIG. 2a coupled to the base of FIG. 1a.

FIG. 4 is a perspective view illustrating an embodiment of a shank.

FIG. 5a is a perspective view illustrating an embodiment of the base of FIG. 1a being mounted to the shank of FIG. 4.

FIG. 5b is a perspective view illustrating an embodiment of the wear surface member of FIG. 2a being coupled to the base and shank of FIG. 5a.

FIG. 5c is a perspective view illustrating an embodiment of the wear surface member of FIG. 2a coupled to the base and shank of FIG. 5a.

FIG. 6 is a perspective view illustrating an embodiment of an agricultural tillage implement including a plurality of the bases, shanks, and wear surfaces of FIG. 5c.

### DETAILED DESCRIPTION

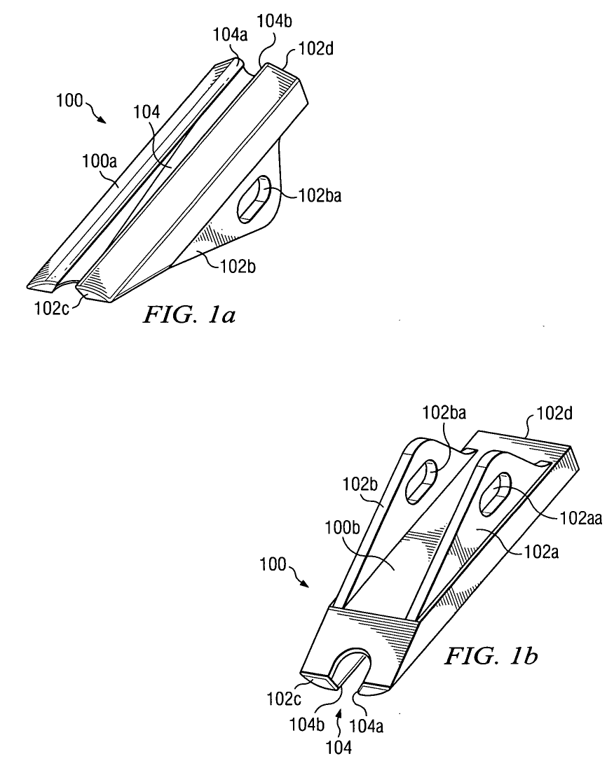

Referring to FIGS. 1a and 1b, a base 100 is illustrated. The base 100 includes a top surface 100a, a bottom surface 100b located opposite the top surface 100a, a front end 102c, and a rear end 102d located opposite the front end 102c. A plurality of coupling fins 102a and 102b extend from the bottom surface 100b and are positioned in a spaced apart relationship on opposite sides of the base 100. Coupling fin 102a defines a coupling aperture 102aa centrally located on the coupling fin 102a. Coupling fin 102b defines a coupling aperture 102ba centrally located on the coupling fin 102b. A first tapered coupling member 104 is centrally located along the length of the base 100. In an embodiment, the first tapered coupling member 104 is a substantially cylindrical channel defined by the base 100 with a coupling lip 104a and a coupling lip 104b positioned on opposite sides of the first tapered coupling member 104. In an embodiment, the first tapered coupling member 104 includes a bi-cylindrical channel defined by the base 100 which provides a channel for a second tapered coupling member having the shape of two cylinders positioned side by side with a flat surface connecting the tops and the bottoms of the two cylinders. In an embodiment, the channel reduces substantially linearly in diameter along the length of the base 100 from a larger diameter adjacent the front end 102c to a smaller diameter adjacent the rear end 102d. While the first tapered coupling member 104 has been shown and described having a substantially cylindrical shape, the first tapered coupling member 104 may include a variety of tapered shapes known in the art. In an embodiment, the base 100 is made from a cast ductile iron of common grade known in the art such as, for example, 6545-12.

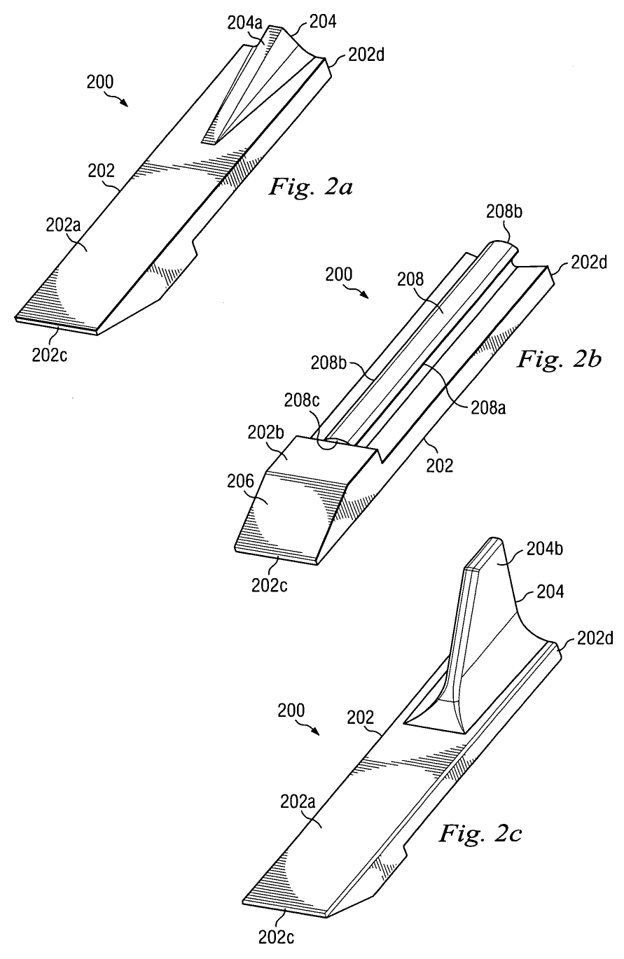

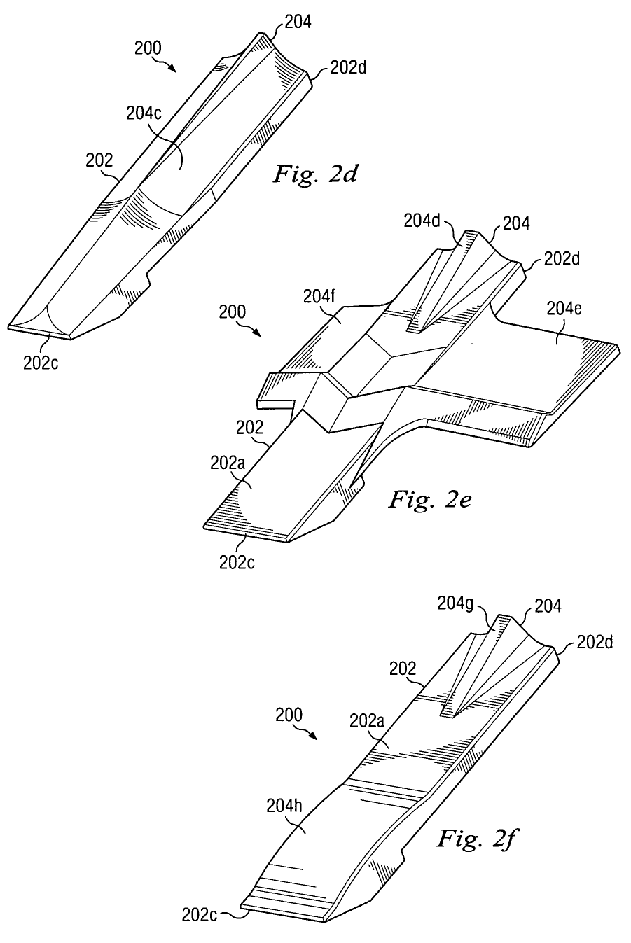

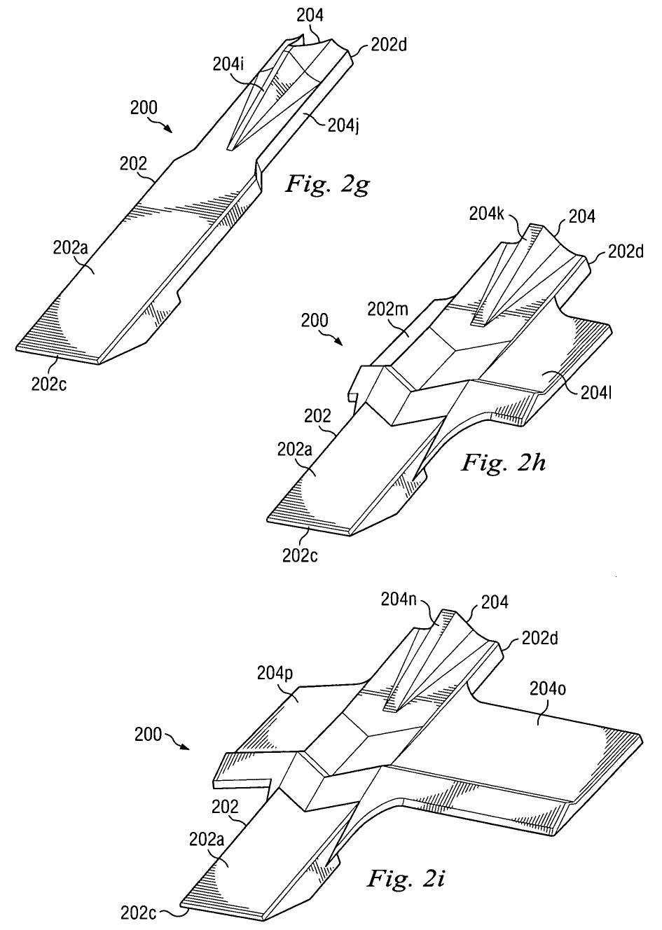

Referring now to FIGS. 2a and 2b, a wear surface member 200 is illustrated. Wear surface member 200 includes an elongated body 202 having a top surface 202a, a bottom surface 202b located opposite the top surface 202a, a front end 202c, and a rear end 202d located opposite the front end 202c. A wear surface configuration 204 extends from the top surface 202a and, in the embodiment illustrated in FIG. 2a, includes a fin 204a located adjacent the rear end 202d. A beveled surface 206 is positioned adjacent the front end 202c and between the bottom surface 202b and the front end 202c. A second tapered coupling member 208 is centrally located partially along the length of the wear surface member 200. In an embodiment, the second tapered coupling member 200 is a substantially cylindrical protrusion extending from the bottom surface 202b of the wear surface member 200, partially along the length of the wear surface member 200, abutting the rear end 202d, and defining a coupling channel 208a and a coupling channel 208b on opposite sides of the second tapered coupling member 200. In an embodiment, the second tapered coupling member 208 includes a bi-cylindrical protrusion having the shape of two cylinders positioned side by side with a flat surface connecting the tops and the bottoms of the two cylinders. In an embodiment, the cylindrical protrusion increases in diameter along its length from a smaller diameter on an end 208b adjacent the rear end 202d to a larger diameter on an end 208c opposite the end 208b. While the second tapered coupling member 208 has been shown and described having a substantially cylindrical shape, the second tapered coupling member 208 may include a variety of tapered shapes known in the art. In an embodiment, the wear surface member 200 is made from a variety of high alloy or heat treated materials known in the art such as, for example, aus-tempered ductile iron. In an embodiment, the wear surface member 200 and the second tapered coupling member 208 are a single piece of material

Referring now to FIGS. 2c, 2d, 2e, 2f, 2g, 2h, and 2i, the wear surface member 200 is illustrating showing, for purposes of example, a plurality of different wear surface configurations 204. As illustrated in FIG. 2c, the wear surface configuration 204 includes a extended fin 204b located adjacent the rear end 202d. As illustrated in FIG. 2d, the wear surface configuration 204 includes a fin 204c that extends along the length of the wear surface member from the front end 202c to the rear end 202d. As illustrated in FIG. 2e, the wear surface configuration 204 includes a fin 204d located adjacent the rear end 202d and a plurality of wings 204e and 204f extending from opposite sides of the elongated body 202. As illustrated in FIG. 2f, the wear surface configuration 204 includes a fin 204g located adjacent the rear end 202d and an arcuate surface 204h extending from the top surface 202a and located between the front end 202c and the top surface 202a. As illustrated in FIG. 2g, the wear surface configuration 204 includes a narrow fin 204i located adjacent the rear end 202d and extending from a narrowed section 204j of the elongated body 202. As illustrated in FIG. 2h, the wear surface configuration 204 includes a fin 204k located adjacent the rear end 202d and a plurality of shortened wings 204l and 204m extending from opposite sides of the elongated body 202. As illustrated in FIG. 2i, the wear surface configuration 204 includes a fin 204n located adjacent the rear end 202d and a plurality of extended wings 204o and 204p extending from opposite sides of the elongated body 202. The embodiments of the wear surface configurations 204 illustrated in FIGS. 2c, 2d, 2e, 2f, 2g, 2h, and 2i, are provided for purposes of example only, and the wear surface configuration 204 may include a variety of other wear surface configurations known in the art which may be chosen based on desired tilling results.

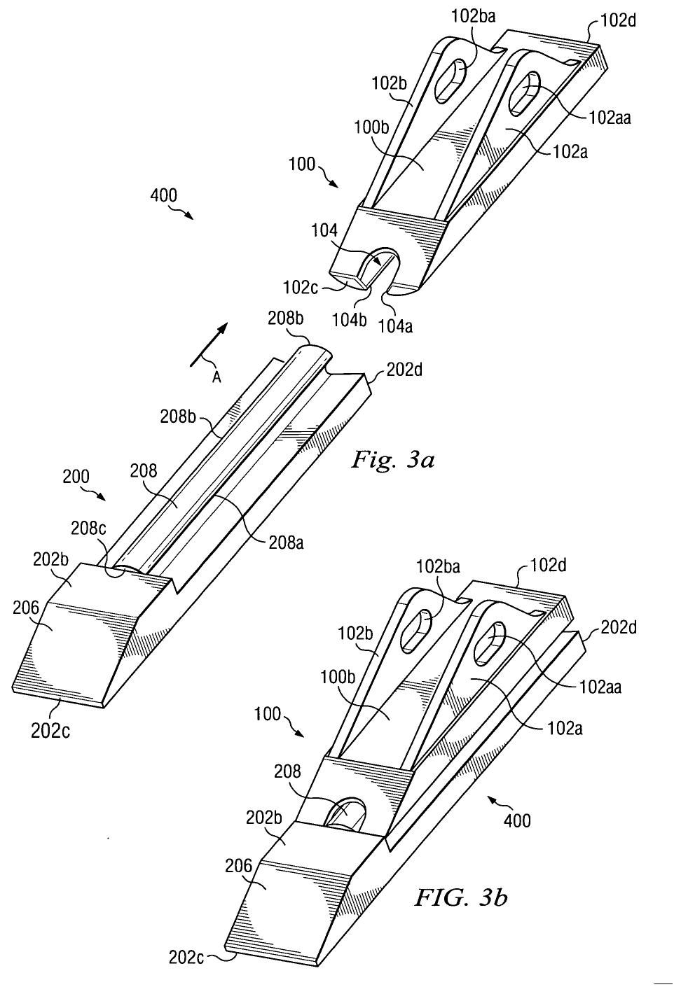

Referring now to FIGS. 3a and 3b, in operation, the wear surface member 200 is positioned adjacent the base 100 such that the rear end 202d of the wear surface member 200 is adjacent the front end 102c of the base 100. Second tapered coupling member 208 on wear surface member 200 is positioned substantially coaxially with first tapered coupling member 104 on base 100. Wear surface member 200 may then be moved in a direction A such that end 208b of second tapered coupling member 200 engages first tapered coupling member 104. Because of the tapering of the first tapered coupling member 104, which has a larger diameter adjacent the front end 102c and a smaller diameter adjacent the rear end 102, and the tapering of the second tapered coupling member 208, which has a smaller diameter on end 208b relative to end 208c, wear surface member 200 may slidingly engage base 100 until the surfaces of first tapered coupling member 104 and second tapered coupling member 208 engage. During engagement of first tapered coupling member 104 and second tapered coupling member 208, coupling lips 104a and 104b on first tapered coupling member 104 are positioned in coupling channels 208a and 208b, which couples the wear surface member 200 to the base 100. In an embodiment, the geometries of the first tapered coupling member 104 and the second tapered coupling member 208 result in an interference fit, and moving the wear surface member 200 further in a direction A after engagement of the surfaces of the first tapered coupling member 104 and the second tapered coupling member 208 such as, for example, during tilling operation, further secures the wear surface member 200 to the base 100. In an alternative embodiment, the first tapered coupling member 104 may include a tapered protrusion extending from the base 100 and the second tapered coupling member 208 may include a tapered channel defined by the wear surface member 200, each which operate in substantially the same manner as described above. In an embodiment, the wear surface member 200 may be removed from the base 100 by striking the rear end 202d of the wear surface member 200 such as, for example, with a tool, and causing the second tapered coupling member 208 to disengage the first tapered coupling member 104. The wear surface member 200 may then be moved in a direction opposite the direction A and decoupled from the base 100. In an embodiment, the base 100 and the wear surface member 200 provide a tillage point system 400.

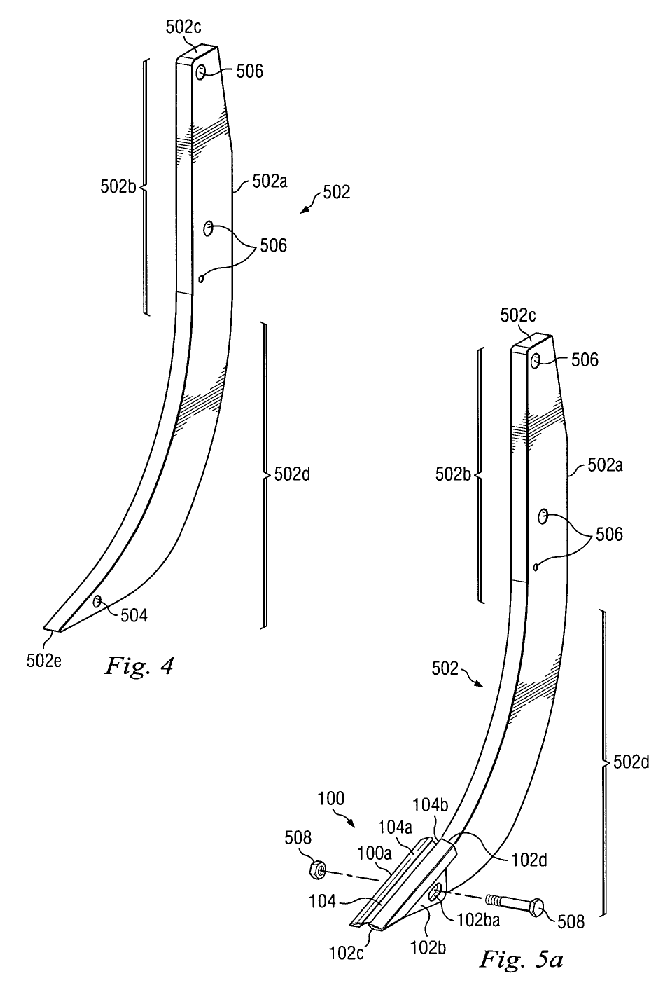

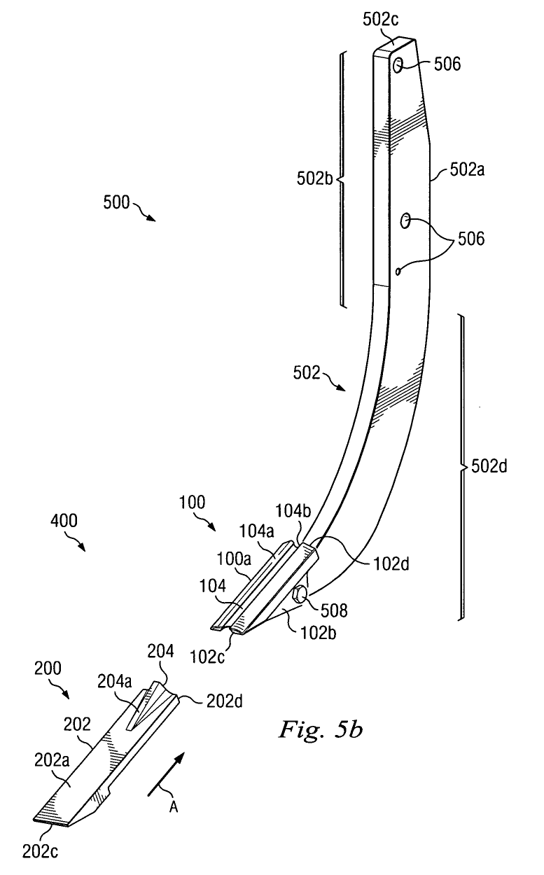

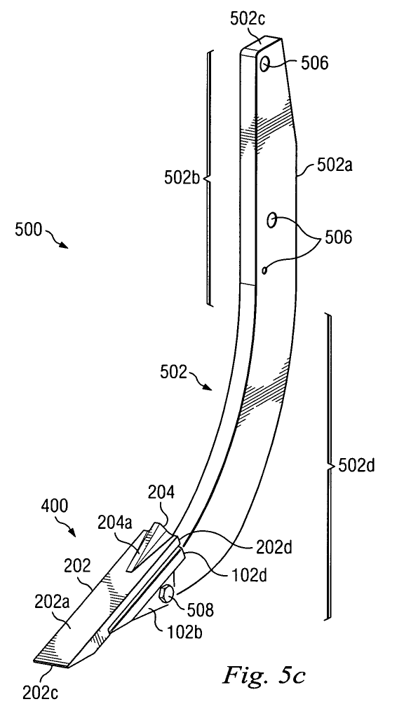

Referring now to FIGS. 4 and 5c, a tillage apparatus 500 is substantially identical in design and operation to the tillage point system 400 described above with reference to FIGS. 1a, 1b, 2a, 2b, 3a, and 3b, with the addition of a shank 502. Shank 502 includes an elongated member 502a having a straight section 502b adjacent an upper flat end 502b and an arcuate section 502d adjacent a lower point end 502e which is located opposite the upper flat end 502b. A base coupler 504 is located adjacent lower point end 502e and, in an embodiment, includes an aperture defined by the elongated body 502a. A plurality of implement couplers 506 are located on straight section 502b and, in an embodiment, include a plurality of apertures defined by the elongated body 502a. In an embodiment, the tillage point system 400 allows the provision of a variety of different wear surfaces for use with a single base such as, for example, the base 100, and/or the provision of a variety of different bases for use with a single wear surface such as, for example, the wear surface 200.

Referring now to FIGS. 1b, 5a and 5b, in assembly operation, the base 100 is coupled to the shank 502 by positioning lower point end 502e on elongated body 502a between coupling fins 102a and 102b such that bottom surface 100b of base 100 engages arcuate section 502d on elongated body 502 adjacent lower point end 502e. Coupling apertures 102aa and 102ba on coupling fins 102a and 102b, respectively, are lined up with base coupler 504 on shank 502 and a coupler 508 is used to secure the base 100 to the shank 502. In an embodiment, the coupler 508 may be a convention coupler known in the art such as, for example, a nut and bolt.

Referring now to FIGS. 3a, 3b, 5b and 5c, in operation, the wear surface member 200 is positioned adjacent the base 100 such that the rear end 202d of the wear surface member 200 is adjacent the front end 102c of the base 100. Second tapered coupling member 208 on wear surface member 200 is positioned substantially coaxially with first tapered coupling member 104 on base 100. Wear surface member 200 may then be moved in a direction A such that end 208b of second tapered coupling member 200 engages first tapered coupling member 104. Because of the tapering of the first tapered coupling member 104, having a larger diameter adjacent the front end 102c and a smaller diameter adjacent the rear end 102, and the tapering of the second tapered coupling member 208, having a smaller diameter on end 208b relative to end 208c, wear surface member 200 may slidingly engage base 100 until the surfaces of first tapered coupling member 104 and second tapered coupling member 208 engage. During engagement of first tapered coupling member 104 and second tapered coupling member 208, coupling lips 104a and 104b on first tapered coupling member 104 are positioned in coupling channels 208a and 208b, which couples the wear surface member 200 to the base 100. In an embodiment, due to the base 100 being made from a ductile material, moving the wear surface member 200 further in a direction A after engagement of the surfaces of the first tapered coupling member 104 and the second tapered coupling member 208 such as, for example, during tilling operation, further secures the wear surface member 200 to the base 100. In an embodiment, the wear surface member 200 may be removed from the base 100 by striking the rear end 202d of the wear surface member 200 with a tool and causing the second tapered coupling member 208 to disengage the first tapered coupling member 104. The wear surface member 200 may then be moved in a direction opposite the direction A and decoupled from the base 100.

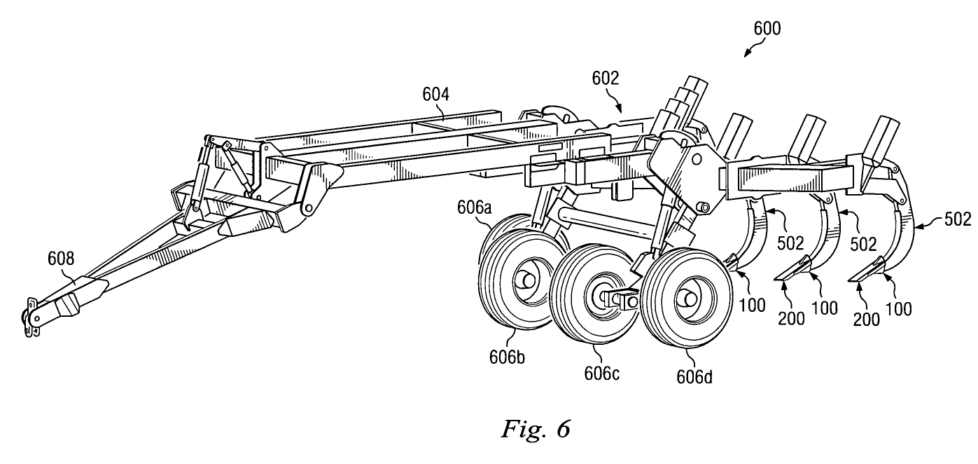

Referring now to FIG. 6, an alternative embodiment of a tillage apparatus 600 is substantially identical in design and operation to the tillage apparatus 500 described above with reference to FIGS. 4, 5a, 5b, and 5c with the addition of an agricultural tillage implement 602. Agricultural tillage implement 602 includes a frame 604 which is coupled to a plurality of wheels 606a, 606b, 606c, and 606d. One end of the frame 602 includes a hitch 608. A plurality of shanks 502 are coupled to the frame 604 with each including a base 100 which is operable to couple a wear surface member 200 to the agricultural tillage implement 602 in the same manner described above with reference to tillage apparatus 500 in FIGS. 4, 5a, 5b, and 5c. In an embodiment, a plurality of agricultural devices known in the art may be coupled to the frame 602. In an embodiment, the hitch 608 may be coupled to a motorized vehicle. In an embodiment, the agricultural tillage implement 602 is motor powered. In an embodiment, the agricultural tillage implement 602 is human powered. In an embodiment, the agricultural tillage implement 602 is animal powered.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A tillage point replacement system comprising:
a base operable to mount to a shank and including a first tapered coupling member; and
a wear surface member including a second tapered coupling member operable to couple the wear surface member directly to the base by engaging the first tapered coupling member.

2. The system of claim 1 wherein the first tapered coupling member includes a tapered socket defined by the base.

3. The system of claim 1 wherein the first tapered coupling member includes a tapered protrusion extending from the base.

4. The system of claim 1 wherein the first tapered coupling member and the second tapered coupling member are operable to couple the wear surface member directly to the base without the use of additional coupling devices.

5. The system of claim 1 wherein the second tapered coupling member includes a tapered protrusion extending from the wear surface member.

6. The system of claim 1 wherein the second tapered coupling member includes a tapered socket defined by the wear surface member.

7. The system of claim 1 wherein the wear surface member and the second tapered coupling member are a single piece of material.

8. A tillage apparatus comprising:
a shank; and
a tillage point system coupled to the shank comprising:
a base mounted to the shank and including a first tapered coupling member; and
a wear surface member including a second tapered coupling member operable to couple the wear surface member directly to the base by engaging the first tapered coupling member.

9. The apparatus of claim 8 wherein the first tapered coupling member includes a tapered socket defined by the base.

10. The apparatus of claim 9 wherein the second tapered coupling member includes a tapered protrusion extending from the wear surface member and operable to slidably engage the tapered socket.

11. The apparatus of claim 8 wherein the first tapered coupling member includes a tapered protrusion extending from the base.

12. The apparatus of claim 11 wherein the second tapered coupling member includes a tapered socket defined by the wear surface member and operable to slidably engage the tapered protrusion.

13. The apparatus of claim 8 wherein the first tapered coupling member and the second tapered coupling member are operable to couple the wear surface member directly to the base without the use of additional coupling devices.

14. The system of claim 8 wherein the wear surface member and the second tapered coupling member are a single piece of material.

15. A tillage apparatus comprising:
an agricultural tillage implement;
a shank mounted to the agricultural tillage implement; and
a tillage point system coupled to the shank comprising:
a base mounted to the shank and including a first tapered coupling member; and
a wear surface member including a second tapered coupling member operable to couple the wear surface member directly to the base by engaging the first tapered coupling member.

16. The apparatus of claim 15 wherein the first tapered coupling member includes a tapered socket defined by the base.

17. The apparatus of claim 15 wherein the first tapered coupling member includes a tapered protrusion extending from the base.

18. The apparatus of claim 15 wherein the first tapered coupling member and the second tapered coupling member are operable to couple the wear surface member directly to the base without the use of additional coupling devices.

19. The apparatus of claim 15 wherein the second tapered coupling member includes a tapered protrusion extending from the wear surface member.

20. The apparatus of claim 15 wherein the second tapered coupling member includes a tapered socket defined by the wear surface member.

21. The apparatus of claim 15 wherein the agricultural tillage implement is coupled to a motorized vehicle.

22. The system of claim 15 wherein the wear surface member and the second tapered coupling member are a single piece of material.

23. A method for providing a replaceable tillage point comprising:
providing a base including a first tapered coupling member;
providing a wear surface member including a second tapered coupling member; and
coupling the wear surface directly to the base by engaging the first tapered coupling member and the second tapered coupling member.

24. The method of claim 23 wherein the providing a wear surface member including a second tapered coupling member includes providing the wear surface member including the second tapered coupling member fabricated from a single piece of material.

25. The method of claim 23 further comprising:
mounting the base to a shank.

26. The method of claim 25 further comprising:
coupling the shank to a agricultural tillage implement.
